(19) United States
(12) Patent Application Publication
(10) Pub. No.: US 2006/0166061 A1
(43) Pub. Date: Jul. 27, 2006

(54) Fuel cell and portable device equipped with the same, and fuel cell operating method

(76) Inventors: Hidekazu Kimura, Tokyo (JP); Tsutomu Yoshitake, Tokyo (JP); Sadanori Kuroshima, Tokyo (JP); Takashi Manako, Tokyo (JP); Suguru Watanabe, Tokyo (JP); Yoshimi Kubo, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/525,840

(22) PCT Filed: Sep. 29, 2003
(86) PCT No.: PCT/JP03/12385

§ 371 Date: Feb. 25, 2005

(30) Foreign Application Priority Data
Sep. 30, 2002 (JP) 2002-286997

(51) Int. Cl. H01M 8/04

(52) U.S. Cl. 429/26; 429/34; 429/4

(57) ABSTRACT

A fuel cell includes a fuel cell main unit (101), a fuel holder (334) and a transforming section (335). The fuel cell main unit (101) includes a fuel electrode (102) and an oxidant electrode (108), and generates electric power based on supplying of organic liquid fuel (124) to the fuel electrode (102) and oxidant (126) to the oxidant electrode (108). The fuel holder (334) stores the organic liquid fuel (124) and supplies the organic liquid fuel (124) to the fuel electrode (102). The transforming section (335) transforms the organic liquid fuel (124) into vapor or mist (337). The fuel holder (334) supplies the vapor or the mist (337) to the fuel electrode (102).

### TECHNICAL FIELD

The present invention relates to a fuel cell that uses an organic compound as a fuel, and an operation method of the same, a portable information device that have the same.

### BACKGROUND ART

Recently, a fuel cell has been receiving increasing attention because of its high power generation efficiency and very little emission of toxic gas. Therefore, it has been researched and developed actively. As for the fuel cell, there are mainly two types one of which uses gas such as hydrogen as fuel, and another of which uses liquid such as methanol as fuel. Since the fuel cell using gaseous fuel need to be equipped with a fuel steel bottle, it has a limit to be downsized. Therefore, it appears promising that a fuel cell using liquid fuel, particularly a direct methanol type fuel cell which does not use a reformer, is used for a power source of a small portable information device such as a portable telephone, a note type personal computer and a PDA (personal digital assisitant).

The electrochemical reactions occurring in the oxidant electrode and the fuel electrode in the direct methanol type fuel cell are respectively represented by the following reaction formulas (1), (2) (Tatsuya Hatanaka, “A Direct Methanol Type Fuel Cell”, R&D Review of Toyota CRDL, Vol. 37, No. 1, p 59-64):
Fuel Electrode: CH₃OH+H₂O→CO₂+6H⁺+6e⁻ (1)
Oxidant Electrode: 3/2O₂+6H⁺+6e⁻→3H₂O (2)

As represented by the reaction formula (1) carbon dioxide is generated in the fuel electrode. In order to produce the electric power smoothly, the methanol needs to be efficiently supplied to the surface of metal catalyst to vigorously induce the reaction of the reaction formula (1). However, in the conventional direct methanol type fuel cell, the supplying of the fuel is carried out by soaking the fuel electrode in the methanol aqueous solution. Therefore, the carbon dioxide generated from the above reaction formula (1) stays in the fuel electrode, and gas bubbles are formed. Consequently, there was the case that the catalyst reaction in the fuel electrode was obstructed. As a result, there was the case that a stable power output was not obtained.

In conjunction with the above mentioned description, Japanese Laid Open Patent Application (JP-A H11-79703) discloses a reformer for a fuel cell including a supersonic wave type atomizing apparatus. In this technique, fuel atomized by the supersonic wave type atomizing apparatus is supplied to the reformer. The reformer reforms the fuel to gas including much hydrogen. This can improve the response of the reformer.

Japanese Laid Open Patent Application (JP-A H5-54900) discloses a polymer electrolyte type fuel cell including a supersonic humidifier. In this technique, the supersonic humidifier is used for humidification of hydrogen as fuel gas. This can improve the control of the humidification of fuel gas.

Japanese Laid Open Patent Application (JP-A 2000-512797, PCT/DE97/01320) disclosesadirect methanol type fuel cell (DMFC). In this technique, a mixture of methanol and water is evaporated by an evaporator and supplied to the fuel cell. At that time, heat of exhaust gas is used for heating of the mixture by a heat exchange.

Japanese Laid Open Patent Application (JP-A 2000-317358) discloses a spray nozzle type mist generator and a mist generator for a fuel cell attaching apparatus. In this technique, by the mist generator using the spray nozzle, liquid fuel becomes mist with very small size and is supplied to the fuel cell. This can supply the mist with very small size supplied stably.

Japanese Laid Open Patent Application (JP-A 2000-191304) discloses a liquid fuel evaporator and a reformer for a fuel cell using the same. In this technique, fuel atomized by a fuel atomizer is heated and evaporated by the liquid fuel evaporator, and supplied to the reformer. The reformer reforms the fuel to gas including much hydrogen. This can activate the evaporator and the reformer activated in very short time.

Japanese Laid Open Patent Application (JP-A 2002-93439) discloses a fuel cell apparatus. In this technique, a liquid fuel is evaporated by a evaporator and supplied to a reformer. When a electric power is decreased rapidly, the gaseous fuel in the evaporator is transmitted to a liquid fuel tank and is recovered by being condensed.

Japanese Laid Open Patent Application (JP-A 2002-216832) discloses a power source system. In this technique, a fuel pack includes a resumption portion that collects by-product material which is produced by a fuel cell. This can suppress bad influence to devices and natural environments.

Japanese Laid Open Patent Application (JP-A 2001-102070) discloses a fuel cell. In this technique, a separation membrane separates generated carbon dioxide and left fuel in the fuel cell. By this, the carbon dioxide, which is unnecessary, can be exhausted and the left fuel can be reused.

### DISCLOSURE OF THE INVENTION

Therefore, an object of the present invention is to provide a fuel cell and a portable information device, in which a carbon dioxide is efficiently removed from a fuel electrode, and a stable output is obtained.

Another object of the present invention is to provide a fuel cell and a portable information device, which has a simply manufacturing process and structure and a high power output.

In order to achieve an aspect of the present invention, the present invention provides a fuel cell including: a fuel cell main unit, a fuel holder, and a transforming section. The fuel cell main unit includes a fuel electrode and an oxidant electrode, and generates electric power based on supplying of organic liquid fuel to the fuel electrode and oxidant to the oxidant electrode. The fuel holder stores the organic liquid fuel and supplies the organic liquid fuel to the fuel electrode. The transforming section transforms the organic liquid fuel into vapor or mist. The fuel holder supplies the vapor or the mist of the organic liquid fuel to the fuel electrode.

The fuel cell of the present invention further includes a controller which control the transforming section based on an output of the fuel cell main unit.

In the fuel cell of the present invention, the organic liquid fuel includes a plurality of compounds. The fuel holder includes a plurality of sub fuel holders, each of which stores corresponding one of the plurality of compounds. The transforming section includes a plurality of sub transforming section, each of which transforms corresponds one of the plurality of compounds into vapor or mist.

In the fuel cell of the present invention, the transforming section transforms the organic liquid fuel into mist by vibrating the organic liquid fuel.

In the fuel cell of the present invention, the transforming section includes a supersonic vibration type atomizing apparatus.

In the fuel cell of the present invention, the supersonic vibration type atomizing apparatus includes a piezoelectric vibrator.

In the fuel cell of the present invention, the transforming section transforms the organic liquid fuel into vapor by heating the organic liquid fuel.

In the fuel cell of the present invention, the transforming section includes a heating apparatus.

In the fuel cell of the present invention, the fuel cell main unit further includes a fuel path and a permeation membrane. The fuel path is arranged on a side of the fuel electrode, and is a path that the organic liquid fuel supplied from the fuel holder flows through to the fuel electrode. The permeation membrane is arranged on a wall of the fuel path, and permeates carbon dioxide generated at the fuel electrode.

In order to achieve another aspect of the present invention, the present invention provides a portable electric device including: a fuel cell and a portable electric device body. To the portable electric device body, electric power is supplied from the fuel cell. The fuel cell including: a fuel cell main unit, a fuel holder and a transforming section. The fuel cell main unit includes a fuel electrode and an oxidant electrode, and generates electric power based on supplying of organic liquid fuel to the fuel electrode and oxidant to the oxidant electrode. The fuel holder stores the organic liquid fuel and supplies the organic liquid fuel to the fuel electrode. The transforming section transforms the organic liquid fuel into vapor or mist. The fuel holder supplies the vapor or the mist of the organic liquid fuel to the fuel electrode.

The portable electric device of the present invention, the fuel cell further includes a controller which control the transforming section based on an output of the fuel cell main In the portable electric device of the present invention, the organic liquid fuel includes a plurality of compounds. The fuel holder includes a plurality of sub fuel holders each of which stores corresponding one of the plurality of compounds. The transforming section includes a plurality of sub transforming section each of which transforms corresponds one of the plurality of compounds into vapor or mist.

In the portable electric device of the present invention, the transforming section transforms the organic liquid fuel into mist by vibrating the organic liquid fuel.

In the portable electric device of the present invention, the transforming section includes a supersonic vibration type atomizing apparatus.

In the portable electric device of the present invention, the supersonic vibration type atomizing apparatus includes a piezoelectric vibrator.

In the portable electric device of the present invention, the transforming section transforms the organic liquid fuel into vapor by heating the organic liquid fuel.

In the portable electric device of the present invention, the transforming section includes a heating apparatus.

In the portable electric device of the present invention, the fuel cell main unit further includes: a fuel path and a permeation membrane. The fuel path is arranged on a side of the fuel electrode, and is a path that the organic liquid fuel supplied from the fuel holder flows through to the fuel electrode. The permeation membrane is arranged on a wall of the fuel path, and permeates carbon dioxide generated at the fuel electrode.

In order to achieve still another aspect of the present invention, the present invention provides an operation method of a fuel cell, including: (a) generating electric power by supplying organic liquid fuel to a fuel electrode and oxidant to an oxidant electrode of a fuel cell; and (b) supplying the organic liquid fuel to a fuel electrode by transforming the organic liquid fuel into mist or vapor.

In the operation method of a fuel cell of the present invention, the organic liquid fuel includes a plurality of compounds. The step (b) includes (b1) controlling supplying amounts of the plurality of compounds based on an output power of the fuel cell.

In the operation method of a fuel cell of the present invention, the step (b) includes (b2) transforming the organic liquid fuel into mist by vibrating the organic liquid fuel.

In the operation method of a fuel cell of the present invention, the step (b) includes (b3) transforming the organic liquid fuel into vapor by heating the organic liquid fuel.

### BRIEF DESCRIPTION OF THE DRAWINGS

FIG. 1 is a sectional view showing an example of the configuration of the embodiment of the fuel cell according to the present invention;

FIG. 2A is a perspective view showing an example of the note type personal computer in which the fuel cell of the present invention is applied;

FIG. 2B is a A-A′ sectional view of the FIG. 2A;

FIG. 3 is a sectional view showing the comparison example of the configuration of the fuel cell;

FIG. 4 is a sectional view showing another example of the configuration of the embodiment of the fuel cell according to the present invention; and

FIG. 5 is a flowchart showing an example of the operation of the embodiment of the fuel cell according to the present invention.

### BEST MODE FOR CARRYING OUT THE INVENTION

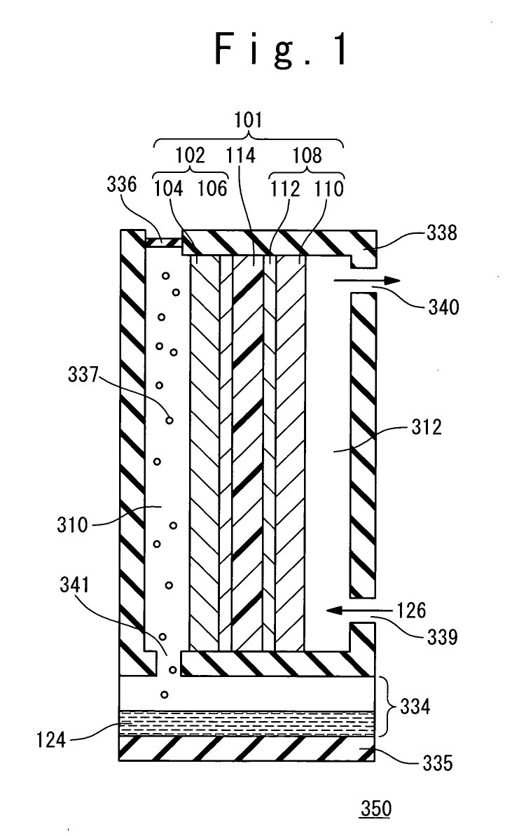

FIG. 1 is a sectional view showing an example of the configuration of the embodiment of the fuel cell according to the present invention. This fuel cell 350 atomizes organic liquid fuel and generates electric power by supplying the atomized fuel to a fuel electrode. The fuel cell 350 includes an electrode-electrolyte assembly 101, a body 338, a fuel holder 334 and a atomizing unit 335.

The electrode-electrolyte assembly 101 is included in and held by the body 338. The electrode-electrolyte assembly 101 includes the fuel electrode 102, an oxidant electrode 108 and a polymer electrolyte membrane 114. The polymer electrolyte membrane 114 is sandwiched between the fuel electrode 102 and the oxidant electrode 108. The fuel electrode 102 is composed of a fuel electrode side (current) collector 104 and a fuel electrode side catalyst layer 106. The oxidant electrode 108 is composed of an oxidant electrode side (current) collector 110 and an oxidant electrode side catalyst layer 112. The fuel electrode side collector 104 and the oxidant electrode side collector 110 have a large number of fine penetration holes (not shown), respectively.

A fuel path 310 is formed between the body 338 and one side of the electrode-electrolyte assembly 101. Also, an oxidant path 312 is formed between the body 338 and another side of the electrode-electrolyte assembly 101. The fuel holder 334 is arranged below the body 338. The atomizing unit 335 is arranged below the fuel holder 334. The fuel holder 334 is connected to the fuel path 310 through the penetrated opening 341 which is formed on a wall of the body 338 of the fuel path 310. The fuel 124 is stored in the fuel holder 334. The fuel holder 334 has a configuration which can be easy to put on and take off. It has an inlet (not shown) through which it can be filled with the fuel 124. The penetrated opening 341 is closed by the cover (not shown) when the fuel cell 350 is not used. The fuel 124, as described later, is supplied to the fuel path 310 as fuel mist 337. On the other hand, the oxidant 126 is supplied to the oxidant path 312 through a inlet opening 339 formed on a wall of the body 338. Then, the oxidant 126 is exhausted through a outlet opening 340 formed on the wall of the body 338. On a part of the wall of the body 338 of the fuel path 310, a penetrated opening or slit is arranged, and a gas permeation membrane through which carbon dioxide can permeate and fuel can not permeate is set in the opening or the slit.

The atomizing unit 335 generates a vibration with high frequency such as supersonic vibration. This vibration is transmitted to the fuel 124 through the fuel holder 334. By this vibration, the fuel 124 is atomized to be the fuel mist 337. The fuel mist 337 is supplied to the fuel path 310 through the penetrated opening 341. Here, the gas permeation membrane 336 does not make the fuel mist 337 as liquid fuel pass through. Therefore, the fuel mist 337 fills the fuel path 310 and the part of the fuel mist 337 reaches the fuel electrode side catalyst layer 106 through fine holes of the fuel electrode side collector 104.

The atomizing unit 335 is exemplified in a supersonic vibration type atomizing unit such as USH-400 made by Akizuki Densi Tsusho Co., Ltd., C-HM-2412 made by K. K. Tech-Jam. These atomizing unit can atomize fuel with good response speed. Also, the supersonic vibration type atomizing unit including a piezoelectric vibrator such as a atomizing disk made by FDK Corporation may also be used. These atomizing unit is a low-power-consumption apparatus. Therefore, retention of gas bubble of carbon dioxide can be prevented and stable condition of generating of electric power can be maintained without increasing load.

The membrane, which can permeate carbon dioxide, may be used for the gas permeation membrane 336. The porous membrane, which is disclosed in the Japanese Laid Open Patent Application JP-A 2001-102070, may also be used. Here, the porous membrane has fine holes with the diameter of 0.05-4 μm and permeates carbon dioxide selectively.

The operation example will be described in case that methanol is used as the fuel 124. In the fuel electrode side catalyst layer 106, the electrochemical reaction occurs, which is shown in the reaction formula (1) mentioned above. This results in the generations of hydrogen ions, electrons and carbon dioxide. The hydrogen ions are passed through the polymer electrolyte membrane 114 and moved to the oxidant electrode 108. Also, the electrons are moved through the fuel electrode side collector 104 and the external circuit to the oxidant electrode 108.

On the other hand, the oxidant 126, such as air, oxygen and the like, is supplied through the oxidant path 312 to the oxidant electrode 108. This oxygen, the hydrogen ion which is generated in the fuel electrode 102 and moved to the oxidant electrode 108 as mentioned above, and the electron react with each other, as shown in the reaction formula (2), and then generates the water. In this way, the electron flows into the external circuit, from the fuel electrode 102 to the oxidant electrode 108. Thus, the electric power is produced.

Here, since carbon dioxide does not move to the oxidant electrode 108, it is necessary to remove carbon dioxide from the fuel electrode 102. As mentioned above, in the conventional direct methanol type fuel cell, gas bubbles of carbon dioxide stays in the fuel electrode, and the reaction of the reaction formula (1) is obstructed. On the other hand, in the fuel cell 350 of the present invention which atomizes and supplies the fuel 124, it is difficult to form the gas bubbles of carbon dioxide because liquid enough to form gas bubbles does not exist around the fuel electrode 102. Consequently, carbon dioxide is transferred to the fuel path 310 through the fuel electrode side collector 104 without retention at the fuel electrode 102. Therefore, the reaction of the reaction formula (1) proceeds stably and the stable output power can be obtained.

After that, carbon dioxide is exhausted through the gas permeation membrane 336 from the fuel cell 350 to outside. At that time, since the fuel mist 337 can not permeate the gas permeation membrane 336, the fuel 124 is not exhausted without using it. Also, the surplus fuel mist 337 becomes droplets on such place like the wall of fuel path 310. These droplets drop along the wall to the fuel holder 334, when they grow bigger than certain size. Then, they are recovered and reused.

Here, the amount of atomized fuel will be estimated which is used for operating an electrical apparatus with power consumption of 20 W. In case of the direct methanol type fuel cell, ideal fuel is 64 wt % methanol aqueous solution. According to FIG. 8 of the above-mentioned related art (Tatsuya Hatanaka, “A Direct Methanol Type Fuel Cell”, R&D Review of Toyota CRDL, Vol. 37, No. 1, p 59-64) , in case of using 64 wt % methanol aqueous solution as a fuel and setting 0.6V as fuel cell working voltage, the energy density is approximately 1.6 Wh/cc. Therefore, to operate the electrical apparatus with power consumption of 20 W, the fuel should be atomized and supplied at the rate of approximately 12.5 cc/h. The supersonic vibration type atomizing unit and the supersonic vibration type atomizing unit including a piezoelectric vibrator as exemplified before satisfy the above-mentioned atomizing ability.

The polymer electrolyte membrane 114 has the role of separating the fuel electrode 102 and the oxidant electrode 108 and also moving the hydrogen ion between both of them. For this reason, the polymer electrolyte membrane 114 is desired to be the membrane in which an electrical conductivity of the hydrogen ion is high. Also, it is desired to be stable in chemistry and also high in mechanical strength. As the material constituting the polymer electrolyte membrane 114, the high polymeric organic substance is preferably used which has a strong acid group such as a sulfone group, a phosphoric acid group, a phosphonic group, a phosphine group and the like, and a weak acid group such as a carboxyl group and the like.

As the fuel electrode side collector 104 and the oxidant electrode side collector 110, it is possible to use the porous substrate such as a carbon paper, a carbon molding, a carbon sinter, a sintered metal, a foam metal and the like.

The catalyst of the fuel electrode 102 is exemplified in platinum, rhodium, palladium, iridium, osmium, ruthenium, rhenium, gold, silver, nickel, cobalt, lithium, lanthanum, strontium, yttrium and the like, an alloy of platinum and at least one of ruthenium, gold and rhenium and the like. On the other hand, as the catalyst of the oxidant electrode 108, it is possible to use the catalyst similar to that of the fuel electrode 102. So, the above exemplified substances can be used. The catalysts of the fuel electrode 102 and the oxidant electrode 108 may be equal or different.

The carbon particle for supporting the catalyst is exemplified in an acetylene black (Denka Black (a registered trademark, made by Denki Kagaku Kogyo K.K.), XC72 (made by Vulcan Corporation) and the like), a carbon black, a ketjen black (made by Ketjen Black International K. K.), a carbon nano-tube, a carbon nano-horn and the like.

As the fuel 124 for the fuel cell, for example, it is possible to use the organic liquid fuel such as methanol, ethanol, dimethyl ether and the like.

Although there is not a special limit on the method of manufacturing the fuel cell 350, for example, it can be manufactured as follows.

At first, the catalyst is supported on the carbon particles. This step can be carried out by using a typically used impregnating method. Next, the carbon particles on which the catalyst are supported and the polymer electrolyte particles, for example, such as NAFION (a registered trademark, made by Du Pont K. K.) are dispersed into solvent and made into paste. Then, this is coated on the substrate and dried so that the catalyst layer can be obtained. After the paste is coated, it is heated at a heating temperature for a heating time, correspondingly to fluorine resin to be used. Consequently, the fuel electrode 102 or the oxidant electrode 108 is manufactured.

The polymer electrolyte membrane 114 can be manufactured by employing a proper method, depending on the usage material. For example, the liquid in which the high polymeric organic substance is solved or dispersed into the solvent is cast and dried on a strippable sheet such as poly-tetra-fluoro-ethylene and the like. Consequently, this can be obtained.

The polymer electrolyte membrane 114 as manufactured above is sandwiched between the fuel electrode 102 and the oxidant electrode 108 to thereby obtain the electrode-electrolyte assembly 101.

The position at which the atomizing unit 335 is arranged is not limited if the vibration is transmitted to the fuel 124 in the fuel holder 334. As shown in FIG. 1, it may be arranged below a bottom or a side of the fuel holder 334. The atomizing unit 335 may be arranged separately from the fuel holder 334 as explained below. One edge of cloth or paper is soaked in the fuel holder 334 and another edge is attached the atomizing unit 335. By this, keeping atomizing function, the fuel holder 334 can be arranged separately from the atomizing unit 335.

Here, as described above, the fuel mist 337 is formed by the atomizing unit 335. However, other method can be used. For example, the fuel is stored the fuel holder with a nozzle, and then the fuel can be atomized by adding the pressure in the fuel holder.

Here, as described above, the fuel mist 337 of the fuel 124 is supplied to the fuel electrode 102. However, the method is not limited to this. For example, vapor of the fuel 124 may be supplied. In this case, instead of the atomizing unit 335, it can be carried out by heating the fuel 124 by the heater.

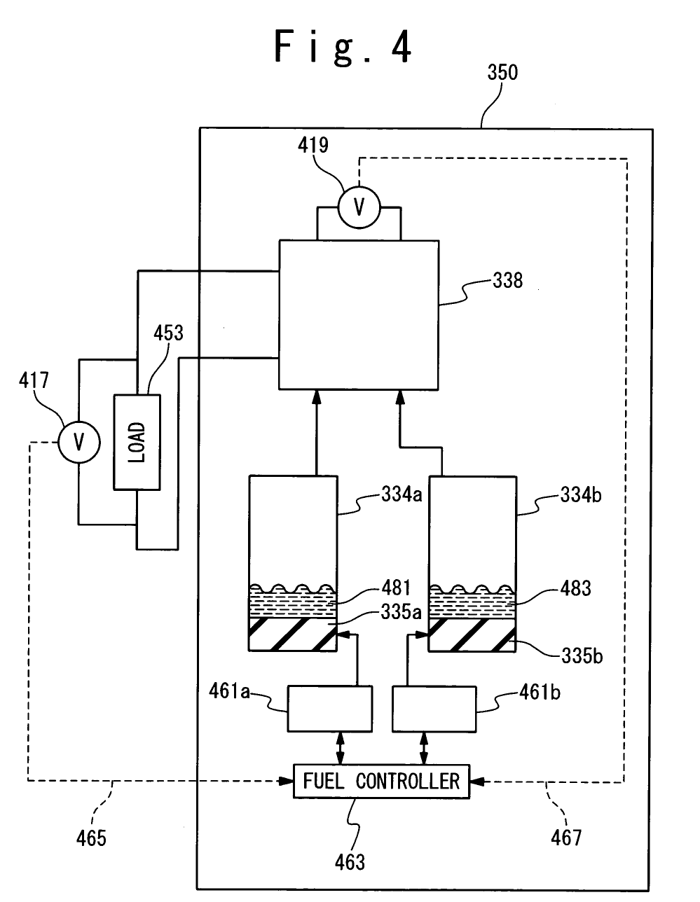

Here, as described above, the fuel cell including one of the fuel holder 334 and one of the atomizing unit 335 is explained. Another embodiment is exemplified in the fuel cell including two of the fuel holder and two of the atomizing unit as shown in FIG. 4.

FIG. 4 is a sectional view showing another example of the configuration of the embodiment of the fuel cell according to the present invention. As for the fuel cell shown in FIG. 4, a first atomizing unit 335a and a second atomizing unit 335b is arranged on a first fuel holder 334a and a second fuel holder 334b, respectively. The first atomizing unit 335a atomizes a first compound 481 to supply it to the body 338 by transmitting vibration to a first fuel holder 334a. Similarly, the second atomizing unit 335b atomizes a second compound 483 to supply it to the body 338 by transmitting vibration to a second fuel holder 334b. The first atomizing unit 335a and the second atomizing unit 335b are connected to a first inverter 461a and a second inverter 461b, respectively, such that a fuel controller 463 controls the amount of atomized fuel.

For example, in case that the first compound 481 is water and the second compound 483 is methanol, the operation of the fuel cell including the control by the fuel controller 463 is carried out explained below.

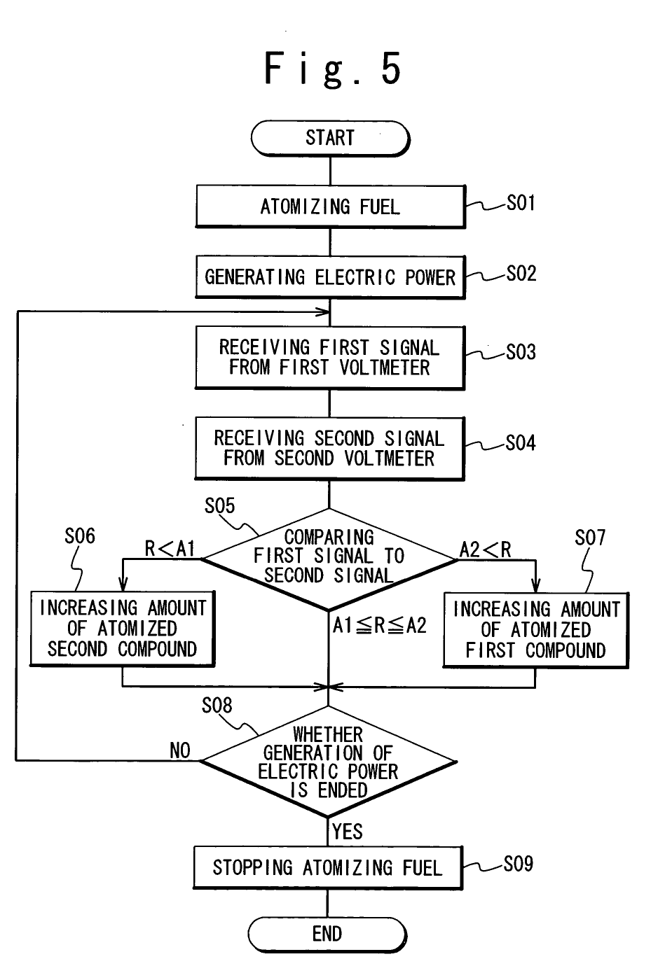

FIG. 5 is a flowchart showing an example of the operation of the embodiment of the fuel cell according to the present invention. Based on an input signal indicating a start of an operation of a fuel cell, the atomizing unit 335a and 335b start atomizing the fuel of the fuel holder 334a and 334b, respectively (step S01). Next, the electrode—electrolyte assembly 101 starts generating electric power by being supplied the fuel (step S02). The fuel controller 463 receives a signal from a load 453 which is a first signal 465 from a first voltmeter 417 (step S03). Also, the fuel controller 463 receives a second signal 467 (reference output) from a second voltmeter 419 (step S04). Then, it compares the first signal 465 to the second signal 467 (step S05). The fuel controller 463 controls the signal from the load 453 such that the ratio or difference between the first signal 465 and the second signal 467 (hereinafter referred to as R) is approximately constant. That is, the fuel controller 463 increases the amount of atomized second compound 483 from the second fuel holder 334b when the R is lower than a reference value A1 (step S06). On the other hand, the fuel controller 463 increases the amount of atomized first compound 481 from the first fuel holder 334a when the R is larger than a reference value A2 (is equal to or larger than A1) (step S07). It maintains the amounts of atomized both compound when the R is in the range of A1 to A2. Here, A1 and A2 are set based on the properties of the fuel cell and its operation method. When the generation of electric power is continued (step S08, NO), the control is repeated from the steps S03. When the generation of electric power is ended (step S08, Yes), the atomizing unit 350a and 350b are stopped (step S09).

In this way, the fuel cell shown in FIG. 4 can controls amount of the supplied water and amount of the supplied methanol by the fuel controller 463. Therefore, consumption of methanol can be the bare minimum and the power output of the fuel cell 350 can be stable.

The above example is described regarding the atomizing units. However, by substituting the heating units such as heaters for the atomizing units, the first compound 481 and the second compound 483 can be evaporated and supplied to the fuel cell 350.

The above explained control of the amounts of atomized compounds or evaporated compounds can be applied to the case that uses one fuel holder as mentioned above.

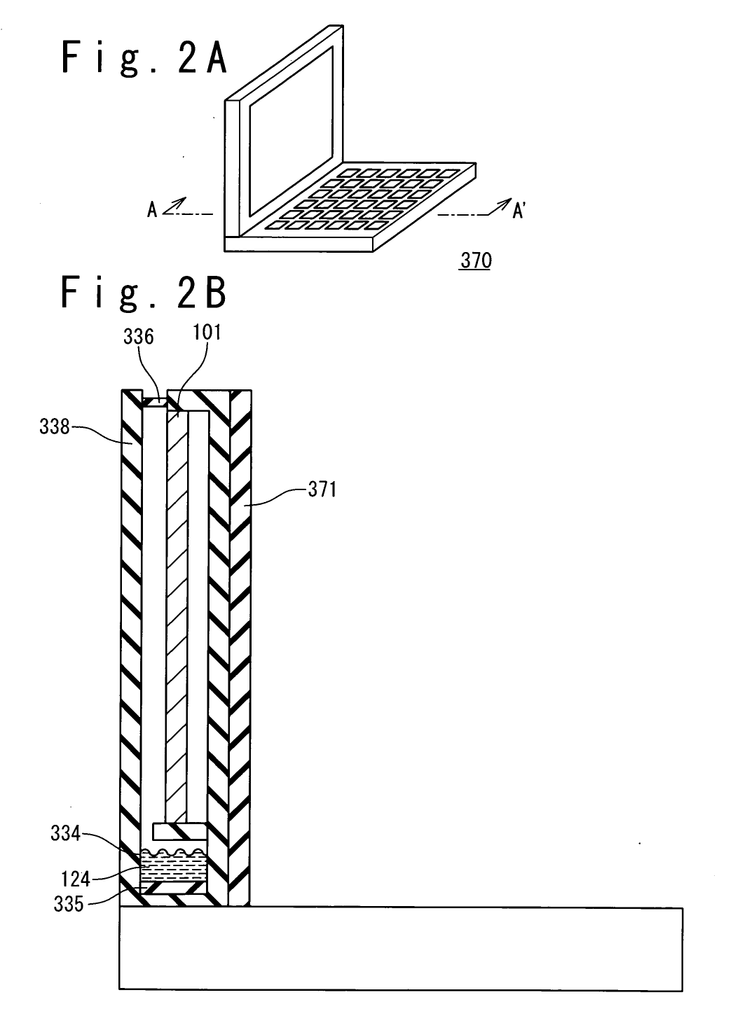

The fuel cell of the present invention is used for the small electric devices (portable electric devices) such as a portable phone, a portable personal computer like a note type personal computer, a PDA (Personal Digital Assistant), various kinds of cameras, a navigation system, a portable music player and the like. The example of the note type personal computer in which the fuel cell is applied is shown in FIGS. 2A and 2B.

FIG. 2A is a perspective view showing an example of the note type personal computer in which the fuel cell of the present invention is applied. FIG. 2B is a A-A′ sectional view of the FIG. 2A. In the note type personal computer 370, the fuel cell is arranged behind a display apparatus 371. Here, in the fuel cell, the electrode-electrolyte assembly 101, the fuel holder 334, the gas permeation membrane 336 and the atomizing unit 335 is arranged in thin-model body 338 as shown in FIG. 2B. By this configuration, a space for arranging the fuel cell in the personal computer is not necessary. Therefore, the fuel cell can be equipped without enlarging the size of the personal computer.

### EXAMPLE

The example will be explained with reference to FIG. 1. In this example, the supersonic vibration type atomizing unit is used as the atomizing unit 335.

In FIG. 1, as the catalyst contained in the fuel electrode side catalyst layer 106 and the oxidant electrode side catalyst layer 112, the catalyst supporting carbon micro particles in which an alloy of platinum (Pt) and ruthenium (Ru) that have a particle diameter of 3 to 5 nm was supported at a weight ratio 50% on a carbon micro particles (Denka black; made by Denki Kagaku Kogyo K.K.). Incidentally, the alloy composition was 50 at % Ru, and the weight ratio of the alloy to the carbon micro particles was 1:1. Then, 5 wt % NAFION solution 18 ml made by Aldrich Chemical K.K. was added to this catalyst supporting carbon particle of 1 g. Then, it was agitated in a supersonic mixer at 50° C. for three hours and made into catalyst paste. This paste was coated by 2 mg/cm² on a carbon paper (TGP-H-120 made by Toray Industries, Inc.), on which the water repelling process using the poly-tetra-fluoro-ethylene was performed, by using a screen printing method. Then, it was dried at 120° C., and the fuel electrode 102 and the oxidant electrode 108 were formed.

Next, the fuel electrode 102 and the oxidant electrode 108, which were generated as mentioned above, were thermally pressed on one sheet of the polymer electrolyte membrane 114 (NAFION made by Du Pont K.K.® and a membrane thickness of 150 μm) at 120° C., and a electrode-electrolyte assembly 101 was manufactured.

Next, the electrode-electrolyte assembly 101 was fixed in the body 338 made from stainless steel such that the fuel path 310 and the oxidant path 312 were constituted. The inlet opening 339, the outlet opening 340 and the penetrated opening 341 were formed in the certain positions in the body 338. Further, the slit was formed above the fuel path. A porous membrane made of polyethylene terephthalate with 70 μm in thickness and 0.1 μm in fine holes' diameter was fixed on the body 338 such that the slit was covered. The epoxy adhesive was used for fixing.

Next, the fuel holder 334 made of polytetrafluoro-ethylene having the opening was arranged below the body 338. Here, the opening was connected to the penetrated opening 341. Further, the supersonic vibration type atomizing unit USH-400 made by Akizuki Densi Tsusho Co., Ltd., as the atomizing unit 335 was fixed on the bottom of the fuel holder 334.

The 64 wt % methanol aqueous solution as the fuel 124 was fed into the fuel holder 334, and the fuel 124 was evaporated at the rate of 180 ml/h. The small air blower was fixed at the inlet opening 339, and then air was supplied to the oxidant path 312. In this situation, as for the output properties between the fuel electrode 102 and the oxidant electrode 108, the cell current is 17 mA/cm² at the cell voltage of 0.45 V. This output property was maintained for more than 10 hours.

### COMPARISON EXAMPLE

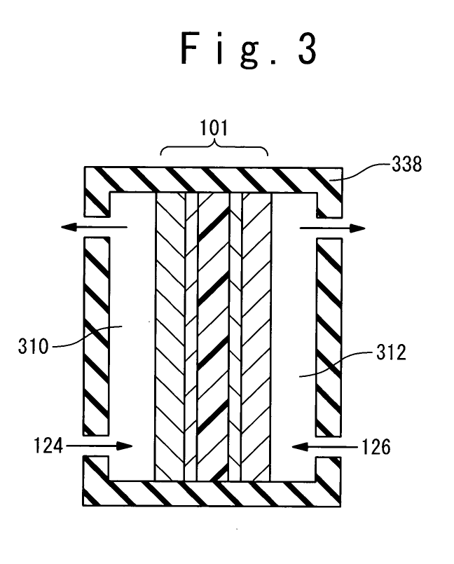

FIG. 3 is a sectional view showing the comparison example of the configuration of the fuel cell. The fuel cell in the comparison example includes the electrode-electrolyte assembly 101, the fuel path 310 and the oxidant path 312 similar to above example. In the oxidant path 312, air as the oxidant 126 was supplied similar to above example. However, in the fuel path 310, the fuel 124 which was not atomized was supplied by a pump different from above example. The fuel 124 is the same as that of above example. The supplying rate of the fuel 124 is 2 ml/min. As for the output properties between the fuel electrode and the oxidant electrode, the cell current is 17 mA/cm² at the cell voltage of 0.45 V. This output property was decreased according to time flow, and became 50% of its original value after 10 hours.

According to the data of the above example and the comparison example, the output properties of the fuel cell of the example is superior to that of the fuel cell of the comparison example. In the fuel cell of the example, the fuel 124 is supplied to the fuel electrode 102 as the fuel mist 337, it is hard to generate the gas bubbles of carbon dioxide in the fuel electrode 102. Therefore, it appears that stay of the gas bubbles of carbon dioxide in the fuel electrode 102, which is the obstruction factor of the electrochemical reaction, occurs extremely rare. So, the cell reaction proceeds more smoothly than that of the comparison example and the superior output properties can be realized.

As mentioned above, according to the present invention, by including a portion (unit, means) which can atomize or evaporate the fuel, the generation of the gas bubbles of carbon dioxide can be suppressed. Therefore, this invention can provide the fuel cell having stable output power.

1. A fuel cell comprising:
a fuel cell main unit which includes a fuel electrode and an oxidant electrode, and generates electric power based on supplying of organic liquid fuel to said fuel electrode and oxidant to said oxidant electrode;
a fuel holder which stores said organic liquid fuel and supplies said organic liquid fuel to said fuel electrode; and
a transforming section which transforms said organic liquid fuel into vapor or mist,
wherein said fuel holder supplies said vapor or said mist of said organic liquid fuel to said fuel electrode.

2. The fuel cell according to claim 1, further comprising:
a controller which control said transforming section based on an output of said fuel cell main unit.

3. The fuel cell according to claim 1, wherein said organic liquid fuel includes a plurality of compounds,
said fuel holder includes a plurality of sub fuel holders, each of which stores corresponding one of said plurality of compounds, and
said transforming section includes a plurality of sub transforming section, each of which transforms corresponds one of said plurality of compounds into vapor or mist.

4. The fuel cell according to claim 1, wherein said transforming section transforms said organic liquid fuel into mist by vibrating said organic liquid fuel.

5. The fuel cell according to claim 4, wherein said transforming section includes a supersonic vibration type atomizing apparatus.

6. The fuel cell according to claim 5, wherein said supersonic vibration type atomizing apparatus includes a piezoelectric vibrator.

7. The fuel cell according to claim 1, wherein said transforming section transforms said organic liquid fuel into vapor by heating said organic liquid fuel.

8. The fuel cell according to claim 7, wherein said transforming section includes a heating apparatus.

9. The fuel cell according to claim 1, wherein said fuel cell main unit further includes:
a fuel path which is arranged on a side of said fuel electrode, and is a path that said organic liquid fuel supplied from said fuel holder flows thorough to said fuel electrode; and
a permeation membrane which is arranged on a wall of said fuel path, and permeates carbon dioxide generated at said fuel electrode.

10. A portable electric device comprising:
a fuel cell; and
a portable electric device body to which electric power is supplied from said fuel cell,
wherein said fuel cell including:
a fuel cell main unit which includes a fuel electrode and an oxidant electrode, and generates electric power based on supplying of organic liquid fuel to said fuel electrode and oxidant to said oxidant electrode;
a fuel holder which stores said organic liquid fuel and supplies said organic liquid fuel to said fuel electrode; and
a transforming section which transforms said organic liquid fuel into vapor or mist,
wherein said fuel holder supplies said vapor or said mist of said organic liquid fuel to said fuel electrode.

11. The portable electric device according to claim 10, wherein said fuel cell further including:
a controller which control said transforming section based on an output of said fuel cell main unit.

12. The portable electric device according to claim 10, wherein said organic liquid fuel includes a plurality of compounds,
said fuel holder includes a plurality of sub fuel holders, each of which stores corresponding one of said plurality of compounds, and
said transforming section includes a plurality of sub transforming section, each of which transforms corresponds one of said plurality of compounds into vapor or mist.

13. The portable electric device according to claim 10, wherein said transforming section transforms said organic liquid fuel into mist by vibrating said organic liquid fuel.

14. The portable electric device according to claim 13, wherein said transforming section includes a supersonic vibration type atomizing apparatus.

15. The portable electric device according to claim 14, wherein said supersonic vibration type atomizing apparatus includes a piezoelectric vibrator.

16. The portable electric device according to claim 10, wherein said transforming section transforms said organic liquid fuel into vapor by heating said organic liquid fuel.

17. The portable electric device according to claim 7, wherein said transforming section includes a heating apparatus.

18. The portable electric device according to claim 1, wherein said fuel cell main unit further includes:
a fuel path which is arranged on a side of said fuel electrode, and is a path that said organic liquid fuel supplied from said fuel holder flows thorough to said fuel electrode; and
a permeation membrane which is arranged on a wall of said fuel path, and permeates carbon dioxide generated at said fuel electrode.

19. A operation method of a fuel cell, comprising:
(a) generating electric power by supplying organic liquid fuel to a fuel electrode and oxidant to an oxidant electrode of a fuel cell; and
(b) supplying said organic liquid fuel to a fuel electrode by transforming said organic liquid fuel into mist or vapor.

20. The operation method of a fuel cell according to claim 19, wherein said organic liquid fuel includes a plurality of compounds,
said step (b) includes:
(b1) controlling supplying amounts of said plurality of compounds based on an output power of said fuel cell.

21. The operation method of a fuel cell according to claim 19, wherein said step (b) includes:
(b2) transforming said organic liquid fuel into mist by vibrating said organic liquid fuel.

22. The operation method of a fuel cell according to claim 19, wherein said step (b) includes:
(b3) transforming said organic liquid fuel into vapor by heating said organic liquid fuel.
